(19) United States
(12) Patent Application Publication
(10) Pub. No.: US 2016/0329630 A1
(43) Pub. Date: Nov. 10, 2016

(54) Modular Antenna Structure

(71) Applicant: NOKIA SOLUTIONS AND NETWORKS OY, Espoo (FI)

(72) Inventors: Harri MUSTAJARVI, Liminka (FI); Eero HEIKKINEN, Oulu (FI)

(21) Appl. No.: 15/108,599

(22) PCT Filed: Dec. 30, 2013
(86) PCT No.: PCT/EP2013/078101

§ 371 Date: Jun. 28, 2016

(51) Int. Cl. H01Q 1/24; H01Q 21/00; H01Q 1/42

(52) U.S. Cl. CPC H01Q 1/246; H01Q 1/42; H01Q 21/0025

(57) ABSTRACT

This document discloses an apparatus including a casing including a base, wherein the base includes fittings for the plurality of antenna elements; the plurality of antenna elements provided in a modular structure in the casing and including at least one common module, a plurality of antenna-specific modules, and a plurality of antenna modules each including at least one antenna, wherein the at least one common module is configured to connect to a plurality of antenna-specific modules and perform at least one signal processing operation commonly for the plurality of antenna-specific modules, wherein each antenna-specific module is configured to connect to a subset of antenna modules, and wherein each antenna module includes a dedicated radio frequency cable connecting the antenna element to an antenna-specific module. Furthermore, a related method is disclosed

### TECHNICAL FIELD

The invention relates to radio frequency antennas and, particularly, to a modular antenna structure.

### TECHNICAL BACKGROUND

Antennas of cellular base stations may be disposed in various places, e.g. antenna towers. A cellular base station antenna may be built into a housing comprising a base and a cover. The cover may be a radome designed to protect antenna electronics from weather. The antenna electronics may be attached to fittings comprised in the base.

### BRIEF DESCRIPTION

The invention is defined by the independent claims.

Embodiments are defined in the dependent claims.

### BRIEF DESCRIPTION OF THE DRAWINGS

In the following the invention will be described in greater detail by means of preferred embodiments with reference to the accompanying drawings, in which

FIGS. 1 and 2 illustrate a base of an antenna arrangement according to an embodiment of the invention, the base comprising a back frame and a grounding frame;

FIGS. 3 and 4 illustrate antenna elements attached to a first side of the base according to an embodiment of the invention;

FIG. 5 illustrates positioning of antenna modules comprising antennas to the base according to an embodiment of the invention;

FIG. 6 illustrates fixing of the antenna modules according to an embodiment of the invention;

FIG. 7 illustrates the antenna arrangement according to an embodiment of the invention; and

FIGS. 8 and 9 illustrate embodiments of division of functions between a common module and antenna-specific modules according to some embodiments of the invention.

### DETAILED DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

Embodiments of the invention relate to a modular antenna structure providing scalability and capability of adapting to various operational situations. According to an embodiment of the invention, there is provided an apparatus comprising a casing comprising a base. In an embodiment, the casing further comprises a cover. The cover may be configured to protect at least some antenna elements comprised in the casing. The base may comprise fittings for the antenna elements. The apparatus may further comprise the antenna elements provided in a modular structure in the casing. The antenna elements may comprise at least one common module, a plurality of antenna-specific modules, and a plurality of antenna modules each comprising an antenna or an antenna array. The common module may be configured to connect to a plurality of antenna-specific modules and perform at least one signal processing operation commonly for the plurality of antenna-specific modules. Each antenna-specific module may be configured to connect to a subset of antenna modules. The subset may comprise one antenna module or multiple antenna modules. Each antenna module may comprise a dedicated radio frequency cable connecting the antenna module to an antenna-specific module. The cover may be arranged to cover and protect the antenna modules. In some embodiments, the cover protects the antenna modules but not the common module and the antenna-specific modules.

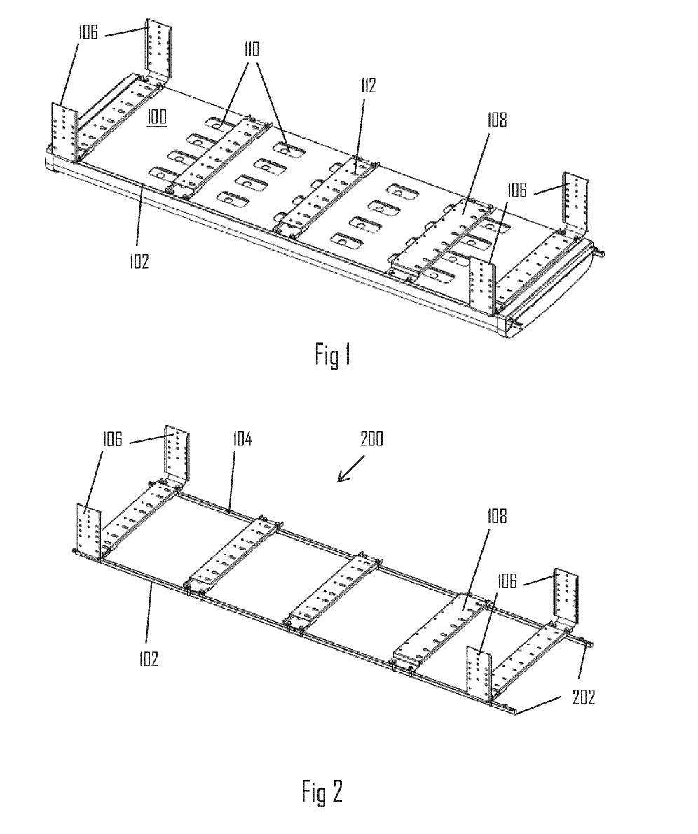

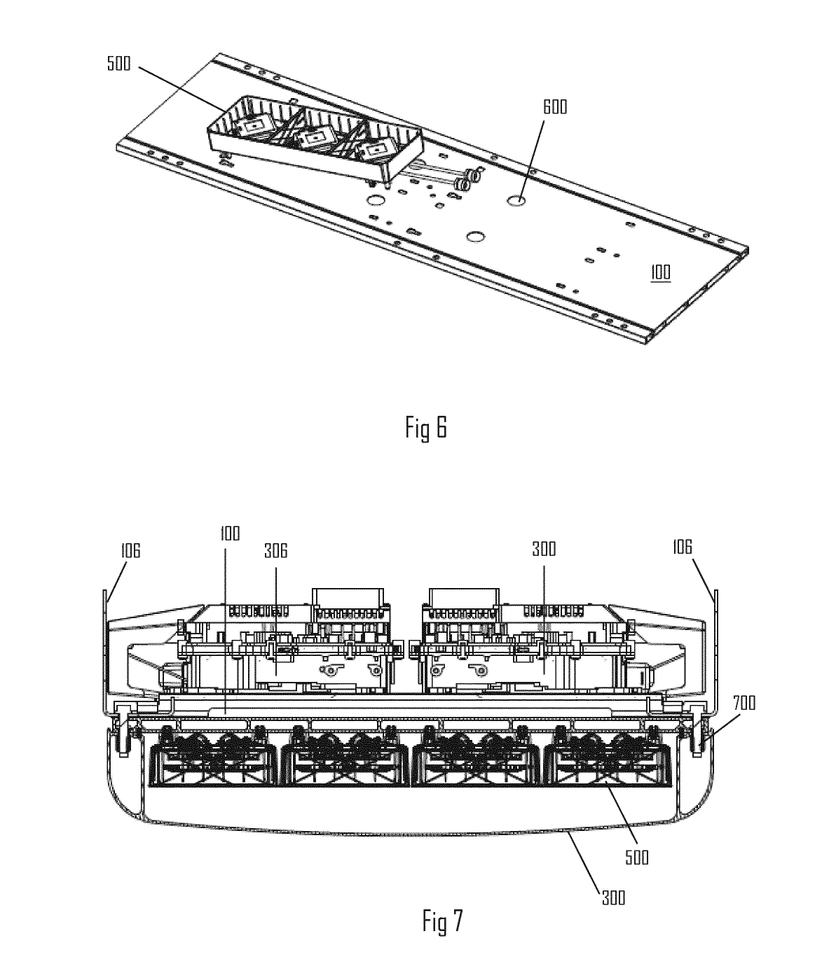

Let us first study the base of the antenna arrangement with reference to FIGS. 1 and 2. Referring to FIG. 1, the base may comprise fittings, 112 for the antenna elements. The fittings, 112 may be designed such that they provide for positioning and attachment of the antenna elements to the base. Correct positioning may be important in some embodiments where the positioning affects radiation patterns, for example. In an embodiment, the fittings comprise recessions or holes to which protrusions of the antenna elements may be positioned. The antenna elements may be fixed to the fittings with snap-fit attachment, for example, as described below with reference to FIG. 6.

Each antenna-specific module may be operationally independent from the other antenna-specific modules. The operational independence of the antenna-specific modules may be defined as each antenna-specific module being grounded individually and/or having a dedicated clock. For example, each antenna-specific module may have a clock signal generator of its own or receive a dedicated clock signal from an external clock signal generator. According to another definition, an antenna-specific module may be removed or attached to the base without any modifications to the other antenna-specific modules.

In an embodiment, each antenna module may be operationally independent from the other antenna modules. As described above, each antenna module may have dedicated radio frequency cabling, e.g. a coaxial cable, that connects the antenna module to its antenna-specific module. In another embodiment, embodiment, the antenna module or a plurality of antenna modules may be integrated into the antenna-specific module in which case the signal lines between the antenna modules and the antenna-specific modules are also integrated signal lines. In yet another embodiment, a blind mate radio frequency connection is employed between the antenna module and the antenna-specific module.

In an embodiment, the antenna modules are provided on a first side of the base 100 while the antenna-specific modules are provided on the other side of the base 100, and the antenna modules may be connected to the antenna-specific modules via through holes 110 provided in the base 100.

The antenna module may be grounded through the cabling to the antenna-specific module which also means that each antenna module is grounded separately. Additionally, the antenna modules connect through separate signal cables to respective the antenna-specific modules. Radiation patterns of the antennas comprised in the antenna modules may be designed such that the radiation pattern remains substantially constant regardless of the operation of the other antenna modules. As the actual radiation pattern is created outside the casing of the antenna modules, the effective radiation pattern of an antenna module is inherently affected by the neighbouring antenna modules. However, the radiation patterns may be designed such that the activation or deactivation of neighbouring antenna modules does not deteriorate the radiation pattern of a given antenna module. In an embodiment, a centralized control may be provided in the common module, for example, to adjust the radiation patterns according to the number of operational antenna modules attached to the base. For example, if a controller comprised in the common module detects that an antenna module configuration has changed as a result of removal, addition, or malfunction of an antenna module, the controller may be configured to adjust the radiation patterns of the other antenna modules to compensate for the effect of the change on their performance. The adjustment may comprise adjusting phasing of signals applied to the antenna modules, for example.

The modular structure may refer to that each antenna element may be attached to or removed from the casing separately. Accordingly, various design configurations may be made by using the same casing which improves scalability of the antenna arrangement. The scalability is further improved by arranging a functional split between the common element and the antenna-specific modules. The same common element may be connected to a various number of antenna-specific modules and the number of antenna-specific modules attached to the casing may be selected according to the design configuration.

The base may comprise a back frame 100 providing the base with mechanical frame and support for the antenna elements. The back frame may be made of metal, e.g. aluminum, or it may be made of electrically inactive material such as plastic or composite material. Plastic materials may be preferred in order to reduce the weight of the antenna arrangement. However, effective grounding and lightning protection may then become an issue. In an embodiment where the back frame is made of electrically inactive material, the base may further comprise a grounding frame. FIG. 2 illustrates an embodiment of the grounding frame 200. The grounding frame 200 may be made of conductive material, e.g. aluminium. FIG. 2 illustrates the grounding frame 200 having a ladder structure comprising grounding bars 102, 104 extending along a longitudinal axis of the back frame 100 and a plurality of rungs 108 interconnecting the grounding bars 102, 104 both mechanically and electrically. The number of the grounding bars may be higher than two and, in some embodiments, only a single grounding bar is used. The ladder structure may be employed even with the single grounding bar by replacing one of the grounding bars 102, 104 with a bar that does not have the grounding property. The rungs 108 may form shelves for the antenna elements, and the fittings may be comprised in the rungs 108 as well, e.g. fitting 112. The fittings 108 may be employed to couple at least some of the antenna elements electrically and mechanically to at least one of the rungs, thus providing grounding for the antenna elements. In some embodiments, at least some of the antenna elements are fixed mechanically to the back frame and coupled electrically to the grounding frame, e.g. the fittings comprised in the back frame 100 may be used for the mechanical fixing, and the electrical coupling may be realized with a coupling that does not fix and/or position the antenna element(s). In some embodiments, the common module and the antenna-specific modules may be attached to the rungs both mechanically and electrically, while the antenna modules may be attached to the back frame 100 mechanically and to the rungs only electrically through the antenna-specific modules.

The grounding frame may be fixed to the base frame with screws, for example.

In an embodiment, the casing comprises at least one grounding connector at an outer surface of the casing, wherein the at least one grounding connector is connected to the grounding bars to provide for lightning protection for the antenna electronics. Referring to FIG. 2, the grounding connectors 106, 202 may be provided at each end of the casing. The grounding connectors 106 may also serve as mechanical fittings with which the antenna is fixed mechanically to a metal structure of a base station tower, for example. Accordingly, the grounding connectors provide for both mechanic fixing of the antenna arrangement and electric grounding. The grounding bars 102, 104 may couple the grounding connectors 106, 202 at the ends of the grounding frame 200. The grounding bars may be sufficiently thick to enable for a lightning strike an easy access through the antenna arrangement through the grounding bars 102, 104 without travelling to the antenna elements. Accordingly, the grounding bars realize efficient lightning protection. In an embodiment, at least some of the grounding connectors, e.g. connectors 202, may be designed such that they provide only the electric coupling to the base station tower. Such connectors 202 may be attached to the metal ground with wire or cable. In an embodiment where the antenna arrangement is applicable to a base station, the grounding bars 202 may be connected to a metal frame of the base station at both ends 106, 202 of the grounding bars to allow an easy path through the grounding frame for the lightning strike, thus protecting the antenna elements.

As described above, the antenna elements may be attached to the fittings 112 of the base. In an embodiment, the antenna elements are designed to be disposed on both sides of the base, e.g. the back frame 100. As illustrated in FIG. 1, the back frame 100 may form a plane and the antenna elements may be disposed on both sides of the plane. The base may comprise one or more through holes to provide a path for cabling through the base.

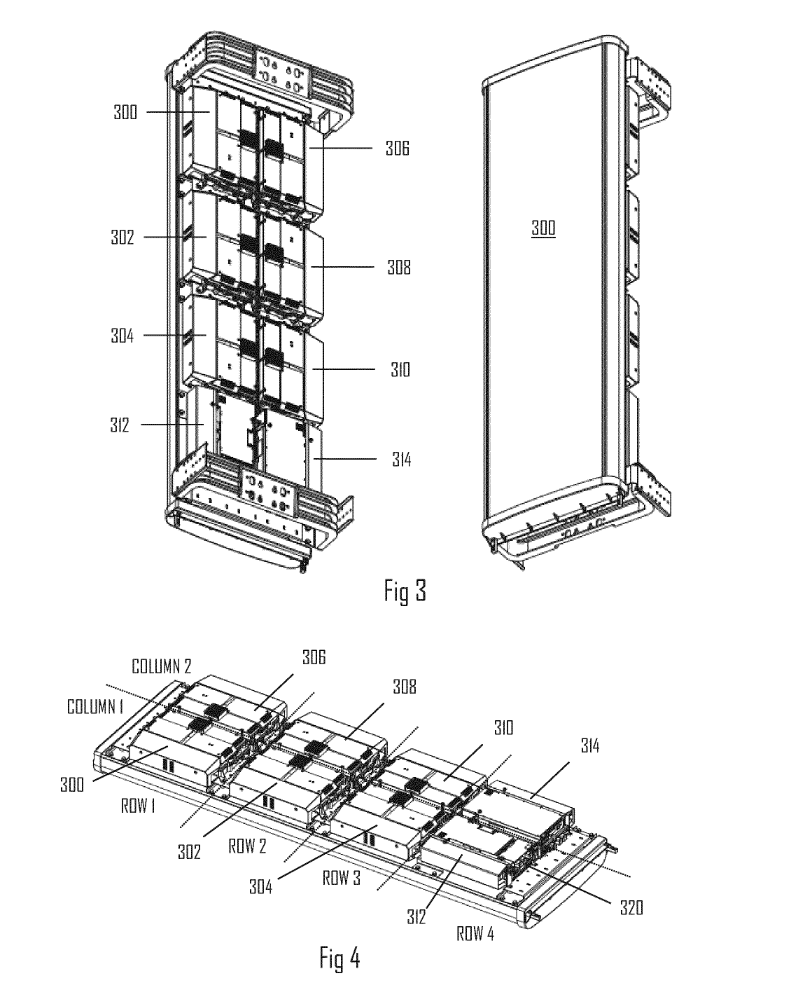

FIG. 3 illustrates an embodiment of the arrangement of the common module 312 and the antenna-specific modules 300, 302, 304, 306, 308, 310 on the base. FIG. 3 illustrates the antenna arrangement on both sides of the base, and the cover 300 is illustrated in the Figure on the right hand side. In an embodiment, the cover 300 comprises a radome commonly used in antenna arrangement to provide cover for the antenna elements. In the embodiment of FIG. 3, the antenna elements are disposed in columns and rows. The antenna elements may comprise one common module 312 that performs at least one function commonly for all antenna-specific modules 300 to 310, or the antenna elements may comprise a plurality of common modules 312, 314 that perform at least one function commonly for different subsets of antenna-specific modules 300 to 310. For example, the common module 312 may be connected to the antenna-specific modules 300, 302, 304, while the common module 314 may be connected to the antenna-specific modules 306, 308, 310. As illustrated in FIG. 4, this arrangement of the antenna elements forms columns and rows and, accordingly, a modular structure. In practice, this arrangement forms two columns and four rows but the number of columns and rows may differ in different embodiments. The columns may extend along the longitudinal axis of the base. The common module(s) 312, 314 may be disposed on one end of the column(s) in order to enable convenient coupling of wires to a system module connected to the antenna arrangement. The common module(s) 312, 314 may comprise one or more connectors 320 in an outer surface of the casing and at the end of the column. The connectors may comprise connectors for a power line and a signal line to the system module. The system module may comprise electronics of the base station, e.g. baseband signal processor(s).

In an embodiment, one column may comprise the common module while another columns comprises no common module. In some embodiments, at least one of the antenna-specific elements may be connected to the common module and at least one of the antenna-specific elements operates without a common module.

In the embodiment of FIGS. 3 and 4, the antenna elements 300 to 314 are disposed horizontally, i.e. they contact the back frame and the grounding frame from a side that has the highest surface area. In another embodiment, the antenna elements 300 to 314 are disposed vertically, i.e. sideways. In this embodiment, the height of the antenna arrangement may be higher but, on the other hand, the width may be reduced or better ventilation may be provided. In an embodiment, a cooler is disposed for each antenna element, and coolers may blow air towards the antenna elements from above (towards the exposed top surface in FIG. 4). The antenna elements and their spacing may be designed such that the air travels along the intersections (see dotted lines in FIG. 4) of the rows and columns and exits the casing from the sides of the casing. Accordingly, each antenna element may be cooled uniformly.

With respect to cabling between the common module 312, 314 and the antenna-specific modules 300 to 310, cable connectors may be provided on an outer side and along the longitudinal axis of the casing. Accordingly, the cables may travel along the column on the outer sides of the antenna elements, and each column may have a separate cabling.

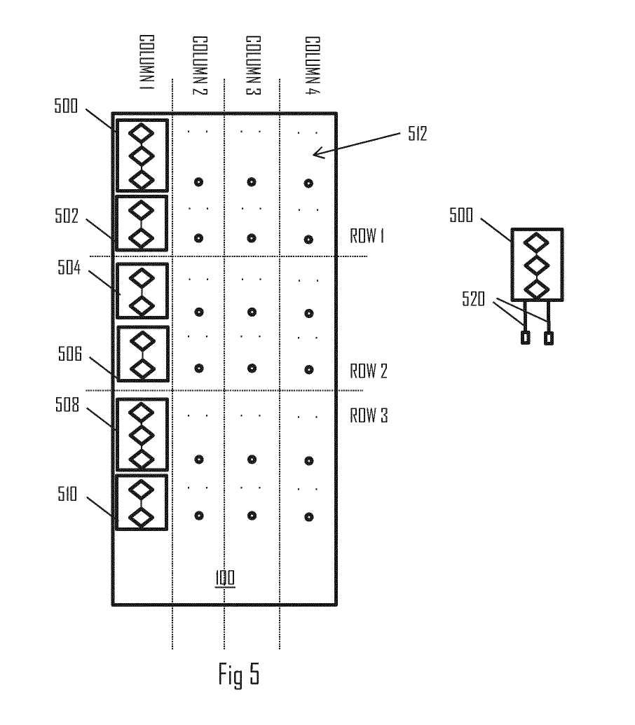

As described above, the common module(s) and the antenna-specific modules may be disposed on one side of the base, and the antenna modules may be disposed on the other side of the base. FIG. 5 illustrates an antenna module 500 and arrangement of the antenna modules 500 to 510 on the base, e.g. the back frame 100. The base may comprise fittings 512 for the antenna modules 500 to 510. As illustrated in FIG. 5, each antenna module 500 to 510 may comprise one or more radio frequency cables 520. In an embodiment, each cable 520 is for a different polarity. In another embodiment, a plurality of cables 520 represent the same polarity. The cable(s) 520 may provide a signal line and a grounding line, and the cable(s) 520 may connect the antenna module to the antenna-specific module, e.g. through the base.

As the antenna-specific modules and the common modules, the antenna modules 500 to 510 may be arranged to form rows and columns. In the embodiment of FIG. 5, four columns and three rows are provided but the number of rows and columns may be different, e.g. two columns and two rows. When considering a location formed by a column index and a row index (e.g. row 1, column 1), one or a plurality of antenna modules may be disposed on each location. For example, two antenna modules may be disposed to each location. An antenna-specific module may be coupled to a single antenna module or to a plurality of antenna modules having the same row and column index. In another embodiment, the antenna-specific module may be coupled to a plurality antenna elements disposed in the same column but a different row. In another embodiment, the antenna-specific module may be coupled to a plurality antenna elements disposed in the same row but a different column. In another embodiment, the antenna-specific module may be coupled to a plurality antenna elements having the same or different polarity. In practice, any combination of coupling the antenna-specific module to the antenna modules is possible depending on the design. Thus, scalability and versatility may be improved.

The antenna elements provided in the different columns and rows may be independent of each other. Depending on the design, some of the columns or rows may be empty, thus improving the scalability of the antenna arrangement. Different number of rows may be employed in different columns. The number of rows comprising the antenna module in a given column may be proportional to the gain of the antenna arrangement, thus improving the performance.

In an embodiment, each column of antenna modules is configured to operate on a dedicated frequency band, and different columns operate on different frequency bands. Accordingly, the capacity of the antenna arrangement may be improved. In another embodiment, antenna modules on at least two columns may be combined to operate on the same frequency band, and thus a narrower radiation beam may be provided. In the embodiment where the plurality of columns is combined, the same antenna-specific module may be coupled to the antenna modules on the combined columns.

This type of arrangement improves the scalability because different antenna configurations may be realized by selecting the appropriate number of antenna modules and attaching them on the appropriate locations on the base. Then, the number and locations of the antenna-specific modules may be selected to comply with the arrangement of the antenna modules. Accordingly, various antenna arrangement designs are possible using the same components.

The base and the locations of the fittings on the base determine the layout of the antenna elements attached to the base.

FIG. 6 illustrates fixing of an antenna module 500 to the base, e.g. the back frame 100. The base may be made of electrically inactive material so the surface of the base to which the antenna modules 500 are fixed may not comprise a reflector. In another embodiment, the base is coated with a reflector surface made of a metallic layer disposed on the back frame 100. The reflector is not necessary but may in some embodiments improve the radiation performance of the antenna modules. In the embodiment of FIG. 6, the base may comprise guiding holes or grooves to which protrusions or hooks provided at a bottom of the antenna module 500 may be first positioned. The guiding hole(s) or groove(s) may position the antenna module 500 such that a locking component at another location on the bottom of the antenna module is positioned against its counterpart in the base. The locking component may be a snap-fit component that locks the antenna module 500 to the base when they are pressed together. The fixing may be ensured by screws or other suitable fasteners afterwards. FIG. 6 illustrates also the through holes 600 through which the cables of the antenna modules may be connected to the antenna-specific modules on the other side of the base.

FIG. 7 illustrates the antenna arrangement in a situation where all the antenna elements are attached to the base, and the cover 300 is disposed to cover the antenna modules 500. FIG. 7 illustrates a cross-sectional view from one end of the base towards a longitudinal direction of the base. The cover 300 may be attached to the base with screws 700, e.g. self-tapping screws. As shown in FIG. 7, the base may comprise a base plate with hollow compartments. The base plate may enclosed from the side of the antenna-specific modules and the common module and comprise holes to the compartments on the side of the antenna modules 500. The holes may form the fittings for the antenna modules. This structure provides for sufficient ingress protection because of the enclosure, while the antenna modules may still be fixed to the base conveniently, e.g. with the snap-fit mechanism. In some embodiments, the cabling between the antenna modules and the antenna-specific modules may be provided through the base. In such embodiments, the pass through the base may be realized such that requirements for a desired ingress protection class are complied with.

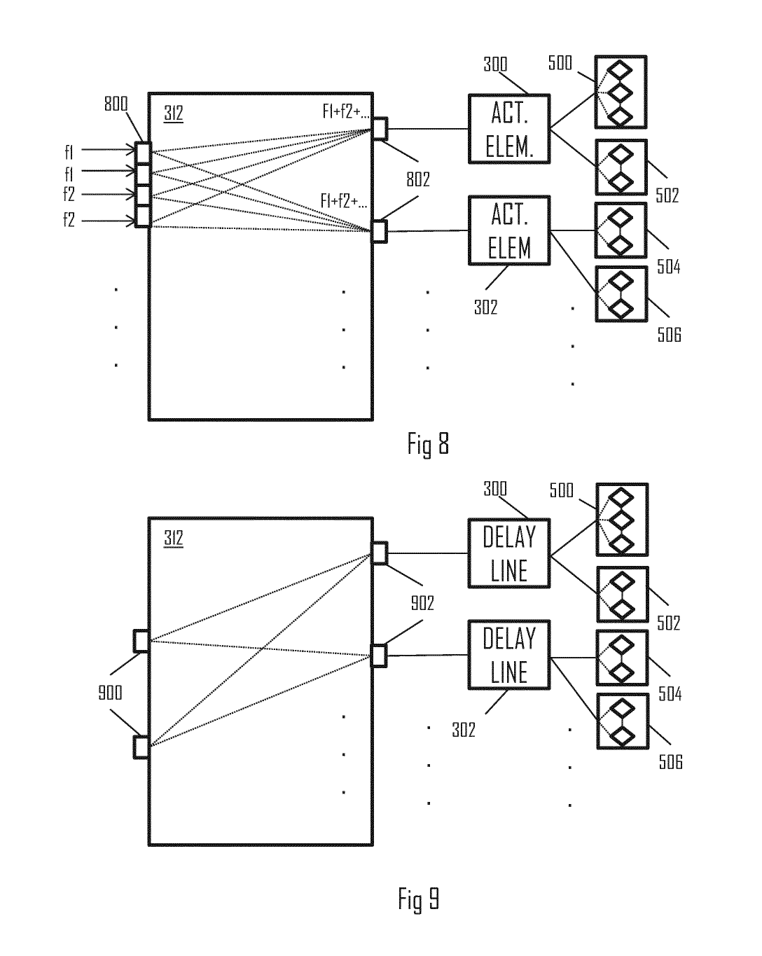

Let us now describe the functions of the common module 312, 314 and the antenna-specific module 300-310 according to some embodiments of the invention with reference to FIGS. 8 and 9. FIG. 8 illustrates an embodiment where the common module 312 and the antenna-specific modules 300-310 are active, e.g. are provided with power supply, while FIG. 9 illustrates a passive implementation of the common module 312 and the antenna-specific modules 300-310.

Referring to FIG. 8, the common module 312 may comprise a first digital input/output (I/O interface 800. The first I/O interface 800 may be provided on an outer surface of the casing to enable connecting the antenna arrangement to the system module of the base station, for example. The common module 312 may comprise a second digital I/O interface connected to the plurality of antenna-specific modules 300-310. The common module 312 may receive a digital base band signal from the system module into the first I/O interface 800. The first I/O interface may comply with at least one of the following standards: Open Base Station Architecture Initiative (OBSAI) and Common Public Radio Interface (CPRI), and Ethernet. The digital base band signal may be a modulated quadrature signal called also an IQ signal. The digital base band signal may be provided to the common module in a plurality of signal streams, wherein each signal stream is a stream for a determined frequency band. In the embodiment of FIG. 8, parallel signal streams are provided for the different frequencies f1, f2 and two streams are provided for each frequency.

In an embodiment, the common module 312 is configured to split signal streams received through the first digital input/output interface 800 to signal streams output to the second input/output interface. In other words, a signal stream received through a port of the first I/O interface 800 is duplicated to each port of the second I/O interface 802. Additionally, the common module may carry out superposition or summation of the signal streams such that the signal streams of different frequency bands are summed together per each port of the second I/O interface 802. This procedure may be carried out during the transmission. In connection with reception, the common module may be configured to compose signal streams received through the second digital input/output interface 802 into signal streams output to the first input/output interface 800. Additionally, the common module may perform frequency separation and output the different frequency components to appropriate ports in the first I/O interface 800. Accordingly, the operation of the common module in connection with the transmission is reversed during the reception. The signal splitting and composure may be performed in the digital domain.

In an embodiment, the number of signal streams at the second input/output interface 802 is higher than the number of signal streams at the first input/output interface 800. Conventionally, the splitting is performed in the system module which increases the number of parallel signal streams and the number of parallel wires between the system module and the antenna arrangement. With the embodiment of FIG. 8, the number and length of wires may be reduced by providing this functionality closer to the antenna modules 500, 502, e.g. in the casing comprising the antenna modules.

In an embodiment, the common module may perform digital beamforming signal processing functions. In an embodiment, the common module may perform calibration functions.

Each port of the second I/O interface 802 may be connected to an antenna-specific module 300, 302. The cabling between the common module and the antenna-specific modules 300, 302 may be digital, e.g. an Ethernet, OBSAI, or CPRI interface. The antenna-specific modules 300, 302 may be active elements in this embodiment. The antenna-specific modules may perform digital-to-analog (D/A) and analog-to-digital (ND) transforms, frequency conversions, and radio frequency (RF) signal processing functions such as RF filtering, amplification, etc. In general, each antenna-specific module 300, 302 may perform radio modem transmit and receive functions. As described above, each antenna-specific module may be coupled to one or more antenna modules 500, 504, and the antenna-specific module may apply an RF transmission signal to its antenna module(s) and received RF signals through the respective antenna module(s).

It should be appreciated that FIG. 8 illustrates only some of the input/output ports of the interfaces 800, 802 and some of the antenna-specific modules and antenna modules of the antenna arrangement.

Referring to the passive implementation of FIG. 9, the common module 312 may comprise a first radio frequency input/output interface 902 connected to the plurality of antenna-specific modules 300, 302 and a second radio frequency input/output interface 900. In this embodiment, the common module comprises a radio frequency splitter configured to split signal streams received from the second radio frequency input/output interface 900 to the first radio frequency input/output interface 902. A reversed operation may be performed in connection with receiving an RF signal through the antenna modules to the first RF I/O interface 902.

The interfaces 900, 902 may comply with an Antenna Interface Standards Group (AISG) interface, for example. The ports of the first RF I/O interface 902 may be connected to the antenna-specific modules 300, 302. The cabling of the interfaces 900, 902 may be realized with RF cabling.

Each antenna-specific module may be a passive module comprising a delay line configured to adjust phases of signals output to the antenna modules. This embodiment enables antenna-specific or antenna-group-specific adjustment of the phases, thus improving the performance of the effective phasing.

In an embodiment, the common module performs at least some of the following functions: operating as a feed network for the antenna-specific modules and the antenna modules, providing control functions of the antenna-specific modules, e.g. controlling the delay of each delay line 300, 302, providing overvoltage protection, providing a bias tee network.

It should be appreciated that while the common module and the antenna-specific modules are in some embodiments called antenna elements while not comprising actual antennas, they may be considered to be antenna elements because they are provided in the same antenna casing as the actual antennas and, thus, form an antenna structure or antenna concealment.

Above, the antenna arrangement has been described from structural point of view. Now, let us consider some embodiments of the arrangement from the functional point of view by describing a technical method carried out by at least some of the antenna elements. In an embodiment, the method comprises: configuring a plurality of antenna-specific modules arranged to be connected to at least one antenna module comprising at least one antenna to perform at least one radio frequency signal processing function; and configuring a common module arranged to be connected to the plurality of antenna-specific modules to perform at least one signal processing function commonly for the plurality of antenna-specific modules.

In an embodiment, the at least one signal processing function of the common module comprises splitting signal streams received through a first digital input/output interface of the common module to signal streams output to a second input/output interface of the common module, and composing signal streams received through the second digital input/output interface to signal streams output to the first input/output interface, wherein the number of signal streams at the second input/output interface is higher than the number of signal streams at the first input/output interface.

In an embodiment, the at least one signal processing function of the common module comprises performing signal processing of spatial beamforming.

In an embodiment, the method further comprises in each antenna-specific module: receiving digital base band signal streams from the common module; converting the received digital base band signal streams into radio frequency signal streams; and outputting the radio frequency signal streams to the antenna modules. In a further embodiment, the at least one signal processing function of the common module comprises performing a radio frequency splitting of signal streams received from a first radio frequency input/output interface to a second radio frequency input/output interface. In a further embodiment, the method further comprises performing, by each antenna-specific module, adjustment of phases of signals output to the antenna modules. In a further embodiment, the method further comprises performing, by each antenna-specific module, dedicated phase adjustment for each antenna module.

At least some of the steps of the method(s) described above may be carried out in the form of a computer process defined by a computer program. For example, the functions performed by the common module operating in the digital domain may be carried out as the computer process(es). The computer program may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The invention is applicable to antenna arrangement described above but also to other antenna solutions. It will be obvious to a person skilled in the art that, as the technology advances, the inventive concept can be implemented in various ways. The invention and its embodiments are not limited to the examples described above but may vary within the scope of the claims.

1. An apparatus comprising:
a casing comprising a base, wherein the base comprises fittings for the plurality of antenna elements;
the plurality of antenna elements provided in a modular structure in the casing and comprising at least one common module, a plurality of antenna-specific modules, and a plurality of antenna modules each comprising at least one antenna,
wherein the at least one common module is configured to connect to a plurality of antenna-specific modules and perform at least one signal processing operation commonly for the plurality of antenna-specific modules, wherein each antenna-specific module is configured to connect to a subset of antenna modules, and wherein each antenna module comprises a dedicated radio frequency cable connecting the antenna element to an antenna-specific module; and
wherein the base comprises a back frame made of electrically inactive material and a grounding frame made of electrically conductive material, and wherein the fittings are comprised in the back frame such that the antenna elements are coupled to the fittings of the back frame mechanically and to the grounding frame electrically.

2. The apparatus of claim 1, wherein each antenna-specific module is grounded individually and/or has a dedicated clock.

3. The apparatus of claim 1, wherein at least some of the antenna elements are attached to the fittings to form columns and rows.

4. The apparatus of claim 3, wherein the antenna modules are attached to the fittings to form columns and rows.

5. The apparatus of claim 3, wherein the antenna-specific modules are attached to the fittings to form columns and rows.

6. The apparatus of claim 3, wherein an antenna-specific module is connected to one or more antenna modules disposed in the same column and/or row.

7. The apparatus of claim 1, wherein a first digital input/output interface of the common module is provided on an outer surface of the casing, and wherein a second digital input/output interface of the common module is connected to the plurality of antenna-specific modules.

8. The apparatus of claim 6, wherein the common module is configured to split signal streams received through the first digital input/output interface to signal streams output to the second input/output interface, and to compose signal streams received through the second digital input/output interface to signal streams output to the first input/output interface, wherein the number of signal streams at the second input/output interface is higher than the number of signal streams at the first input/output interface.

9. The apparatus of claim 7, wherein the common module is configured to perform signal processing of spatial beamforming.

10. The apparatus of claim 1, wherein the common module comprises a first radio frequency input/output interface connected to the plurality of antenna-specific modules and a second radio frequency input/output interface, and wherein the common module comprises a radio frequency splitter configured to split signal streams received from the second radio frequency input/output interface to the first radio frequency input/output interface.

11. The apparatus of claim 8, wherein the antenna-specific modules each comprise a delay line configured to adjust phases of signals output to the antenna modules.

12. The apparatus of claim 9, wherein a dedicated delay line is provided for each antenna module.

13. (canceled)

14. The apparatus of claim 1, wherein the grounding frame forms a ladder structure comprising at least bars extending along a longitudinal axis of the back frame and a plurality of rungs interconnecting the bars mechanically, wherein at least one of the bars is a grounding bar connecting to the plurality of rungs both mechanically and electrically, and wherein each antenna element is coupled electrically and mechanically to at least one of the rungs.

15. The apparatus of claim 1, wherein the casing comprises at least one grounding connector at an outer surface of the casing, wherein the at least one grounding connector is connected to the grounding bar to provide for lightning protection for the antenna electronics.

16. The apparatus of claim 12, wherein the apparatus is a base station antenna apparatus, and wherein the grounding bar is connected to a metal frame of the base station at both ends of the grounding bar.

17. The apparatus of claim 1, wherein the antenna modules are attached to the fittings on an opposite side of the base than the at least one common module and the plurality of antenna-specific modules.

18.-25. (canceled)
